(19) United States
(12) Patent Application Publication
(10) Pub. No.: US 2024/0289744 A1
(43) Pub. Date: Aug. 29, 2024

(54) EFFICIENT PROCESSING USING ADDRESS TYPE

(71) Applicant: DoorDash, Inc., San Francisco, CA (US)

(72) Inventors: Sushil Vellanki, Dublin, CA (US); Xun Liu, San Jose, CA (US); Aniket Patil, Milpitas, CA (US); Rohit Ramkumar, Oakland, CA (US); Saloni Choudhary, San Francisco, CA (US)

(73) Assignee: DoorDash, Inc., San Francisco, CA (US)

(21) Appl. No.: 18/585,972

(22) Filed: Feb. 23, 2024

Related U.S. Application Data
(60) Provisional application No. 63/487,072, filed on Feb. 27, 2023.

(51) Int. Cl. G06Q 10/087; G06Q 10/0835

(52) U.S. Cl. CPC G06Q 10/087; G06Q 10/0835

(57) ABSTRACT

A method is disclosed. The method includes receiving, by a server computer comprising a machine learning model, a fulfillment request including an address from an end user device operated by an end user. The method also includes determining an address type associated with the address, and performing, by the server computer, further processing based upon the address type.

### CROSS-REFERENCES TO RELATED APPLICATIONS

This application is a non-provisional application of U.S. Provisional Application No. 63/487,072 filed on Feb. 27, 2023, which is herein incorporated by reference in its entirety.

### SUMMARY

Embodiments of the present disclosure are directed to computerized systems and methods for determining address types (e.g., high rise building, single family home, hospital, school, etc.) associated with addresses in relation to item fulfillments. The address type can be determined through analysis of transporter location data that is collected when transporters deliver items to end users.

One embodiment of the invention includes a method comprising: receiving, by a server computer comprising a machine learning model from an end user device operated by an end user, a fulfillment request for an item the fulfillment request comprising an address of the end user; determining, by the server computer comprising the machine learning model, an address type associated with the address of the end user; and performing, by the server computer comprising the machine learning model, further processing based upon the address type associated with the address of the end user.

Another embodiment of the invention includes a server computer comprising: a processor; and a non-transitory computer readable medium coupled to the processor, a non-transitory computer readable medium coupled to the processor, the non-transitory computer readable medium comprising a machine learning model, and code, executable by the processor for performing a method comprising: receiving, from an end user device operated by an end user, a fulfillment request for an item the fulfillment request comprising an address of the end user, determining an address type associated with the address of the end user, and performing further processing based upon the address type associated with the address of the end user.

Prior to describing embodiments in more detail, it may be helpful to review some terms used throughout this disclosure.

### TERMS

A “server computer” may refer to a computer or cluster of computers. A server computer may be a powerful computing system, such as a large mainframe. Server computers can also include minicomputer clusters or a group of servers functioning as a unit. In one example, a server computer can include a database server coupled to a web server. A server computer may comprise one or more computational apparatuses and may use any of a variety of computing structures, arrangements, and compilations for servicing requests from one or more client computers.

A “client computer” may refer to a computer or cluster of computers that receives some service from a server computer (or another computing system). The client computer may access this service via a communication network such as the Internet or any other appropriate communication network. A client computer may make requests to server computers including requests for data. As an example, a client computer can request a video stream from a server computer associated with a movie streaming service. As another example, a client computer may request data from a database server. A client computer may comprise one or more computational apparatuses and may use a variety of computing structures, arrangements, and compilations for performing its functions, including requesting and receiving data or services from server computers.

A “memory” may refer to any suitable device or devices that may store electronic data. A suitable memory may comprise a non-transitory computer readable medium that stores instructions that can be executed by a processor to implement a desired method. Examples of memories including one or more memory chips, disk drives, etc. Such memories may operate using any suitable electrical, optical, and/or magnetic mode of operation.

A “processor” may refer to any suitable data computation device or devices. A processor may comprise one or more microprocessors working together to achieve a desired function. The processor may include a CPU that comprises at least one high-speed data processor adequate to execute program components for executing user and/or system generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xenon, and/or Xscale; and/or the like processor(s).

A “message” may refer to any information that may be communicated between entities. A message may be communicated by a “sender” to a “receiver,” e.g., from a server computer sender to a client computer receiver. The sender may refer to the originator of the message and the receiver may refer to the recipient of a message. Most forms of digital data can be represented as messages and transmitted between senders and receivers over communication networks such as the Internet.

A “user” may refer to an entity that uses something for some purpose. An example of a user is a person who uses a “user device” (e.g., a smartphone, wearable device, laptop, tablet, desktop computer, etc.). Another example of a user is a person who uses some service, such as a person who uses a delivery service, a member of an online video streaming service, a person who uses a tax preparation service, a person who receives healthcare from a hospital or other organization, etc. A user may be associated with “user data,” data which describes the user or their use of something (e.g., their use of a user device or a service). In some circumstances, a user may be referred to as an “end user.”

A “user device” may be any suitable electronic device that can be used by a user. An exemplary user device can process and communicate information to other electronic devices. The user device may include a processor and a computer-readable medium coupled to the processor, the computer-readable medium comprising code, executable by the processor. The user device may also each include an external communication interface for communicating with other entities. Examples of user devices may include mobile devices such as mobile phones and laptop computers, wearable devices (e.g., glasses, rings, watches, etc.), hardware modules in larger devices such as vehicles (e.g., automobiles), etc.

A “transporter” can be an entity that transports something. For example, a transporter can be a person that transports an item using a transporter vehicle (e.g., a car). In other embodiments, a transporter can be a transporter vehicle that may or may not be operated by a human. Examples of transporter vehicles include cars, boats, scooters, bicycles, drones, airplanes, etc.

A “fulfillment request” can be a request to provide a resource in response to the fulfillment request. For example, a fulfillment request can include an initial communication from an end user device to a central server computer for a first service provider computer to fulfill a purchase request for a resource, e.g., a purchase request for food from a restaurant. A fulfillment request can include one or more selected items from a selected service provider. A fulfillment request can also include user features of the end user providing the fulfillment request.

An “item” can include an individual article or unit. An item can be a thing that is provided by a service provider. Items can be goods such as bowls of soup, soda cans, toys, clothing, etc. An item can be delivered from a service provider location to an end user location by a transporter.

A “feature” can be an individual measurable property or characteristic of a phenomenon. One or more features can be described using a “feature vector,” e.g., a structured list of data (such as numerical data) representing those features. A feature can be input into a model to determine an output. As an example, in pattern recognition and machine learning, a feature vector can comprise an n-dimensional vector of numerical features that represent some object. In some machine learning contexts, a numerical representation of objects facilitate processing and statistical analysis. For image processing, for example, feature values might correspond to the pixels of an image. As another example, when feature vectors represent text, the features may comprise occurrence frequency of textual terms. Feature vectors can be equivalent to the vectors of explanatory variables used in statistical procedures such as linear regression.

“User features” can include attributes or aspects of a user. User features can include features that relate to a user. For example, in the context of a delivery service, user features can include order history, delivery location, dietary preferences, user ratings, user comments, user feedback, saved service providers, favorited service providers, a current location, food category preferences, delivery time thresholds (e.g., deliver within 1 hour, 45 minutes, etc.), budget preferences, and/or other data representative of, or input by, the user.

“Service provider features” can include attributes or aspects of a service provider. Service provider features can include features that relate to a service provider. Service provider features can include service provider details, cuisine, ratings, food category, service provider location(s), item production time, promoted items, item cost, and/or other data representative of the service provider and/or items provided by the service provider.

The term “artificial intelligence model” or “machine learning model” can include a model that may be used to predict outcomes to achieve a pre-defined goal. A machine learning model may be developed using a learning process, in which training data is classified based on known or inferred patterns.

“Machine learning” can include an artificial intelligence process in which software applications may be trained to make accurate predictions through learning. The predictions can be generated by applying input data to a predictive model formed from performing statistical analyses on aggregated data. A model can be trained using training data, such that the model may be used to make accurate predictions. The prediction can be, for example, a classification of an image (e.g., identifying images of cats on the Internet) or as another example, a recommendation (e.g., a movie that a user may like or a restaurant that a consumer might enjoy).

A “machine learning model” may include an application of artificial intelligence that provides systems with the ability to automatically learn and improve from experience without explicitly being programmed. A machine learning model may include a set of software routines and parameters that can predict an output of a process (e.g., identification of an attacker of a computer network, authentication of a computer, a suitable recommendation based on a user search query, etc.) based on feature vectors or other input data. A structure of the software routines (e.g., number of subroutines and the relation between them) and/or the values of the parameters can be determined in a training process, which can use actual results of the process that is being modeled, e.g., the identification of different classes of input data. Examples of machine learning models include support vector machines (SVM), models that classify data by establishing a gap or boundary between inputs of different classifications, as well as neural networks, collections of artificial “neurons” that perform functions by activating in response to inputs. A machine learning model can be trained using “training data” (e.g., to identify patterns in the training data) and then apply this training when it is used for its intended purpose. A machine learning model may be defined by “model parameters,” which can comprise numerical values that define how the machine learning model performs its function. Training a machine learning model can comprise an iterative process used to determine a set of model parameters that achieve the best performance for the model.

### BRIEF DESCRIPTION OF THE DRAWINGS

FIG. 1 shows a system block diagram of an exemplary item fulfillment service system according to some embodiments.

FIG. 2 shows a block diagram of a central server computer according to embodiments.

FIG. 3 shows a flow diagram illustrating an exemplary preparation and delivery method according to embodiments.

FIG. 4 shows a flow diagram of illustrating a method to determine an address type using a machine learning model according to embodiments.

FIG. 5 shows data showing transporter location data points associated with a delivery.

### DETAILED DESCRIPTION

In an item fulfillment service (e.g., a delivery service), “providers” (also referred to as “service providers” or “resource providers”) can prepare items for users upon receiving “fulfillment requests” (e.g., orders) from those users. These items can be retrieved by “transporters” (e.g., delivery drivers) who can then transport the items to their respective end users, thereby servicing the fulfillment request. For example, in a food delivery service, an end user (e.g., a customer) can order a meal from a restaurant (service provider). A delivery driver (transporter) can then pick up that meal and drive it to the end user.

There are a variety of ways in which the quality of an item fulfillment service can be evaluated. As an example, users typically prefer to receive items quickly rather than slowly, and as such, the total amount of time it takes for a user to receive their items is a useful metric for evaluating a delivery service. Other factors, such as the correctness of the item fulfillment (e.g., whether the user received the items they requested) are also relevant. Many item fulfillment service organizations are interested in improving both the user experience and the experience of transporters. Additionally, item fulfillment service organizations sometimes want to minimize the amount of time between when the transporter picks up the order and when an end user receives their order.

A navigation service on a transporter user device can provide live, step-by-step driving instructions to a transporter throughout the delivery. The navigation service can help guide the transporter to a destination (e.g., service provider location for item pickup, or the delivery address for item drop off). However, the delivery guidance from the navigation service may end once the transporter arrives at or near the destination.

When a transporter arrives at the delivery address with an item to be delivered, they must ensure that the item reaches the end user (e.g., a customer). This often requires the transporter to leave their transporter vehicle and carry the item to a suitable drop-off point. Each order may have a unique drop-off protocol for dropping off one or more items to be delivered to the end user. In some cases, an end user can specify the drop-off point and protocol when they submit a fulfilment request to have the item delivered. For example, some end users may request that ordered items be left at their front doorstep, while other end users may prefer that ordered items be left at a front desk of a lobby if they live in a high-rise apartment building. However, end users that order items to be delivered often do not specify drop-off protocols. If an end user does not specify a drop-off protocol for an ordered item, it remains up to the transporter delivering the item to ensure that the order is quickly and efficiently delivered to the most accessible location for the end user.

It is challenging for transporters to deliver items to end users if their delivery addresses are associated with difficult address types. For example, if the delivery address is in a large apartment complex and the transporter is not familiar with it, the transporter may a spend significant amount of time navigating the large apartment complex until the transporter reaches delivery address. In another example, if the delivery address of an end user is on a high floor in a high-rise building, the transporter will have to use an elevator or stairs to deliver the item to the end user. In yet another example, if the delivery address is a school, the school may have restricted access and require that the transporter drop off the item at its front office. Each of these situations presents challenges to transporters attempting to deliver items to the end users, and increases the time to deliver the items to the end users.

Conventionally, the address types of delivery addresses associated with deliveries are unknown. The transporters do not know the drop-off protocols for items to be delivered to those delivery addresses. In some cases, transporters may reject fulfillment requests associated with items that are heavy, because they cannot determine if the delivery of the items will require extensive effort at the delivery locations. Furthermore, if the item to be delivered is prepared food, then the quality of the delivered item may degrade if the time needed to deliver the item increases (e.g., the prepared food may get cold).

Knowing the drop-off protocol associated with a delivery address prior to arrival can reduce the time needed to deliver items to that delivery address. If a transporter knows a drop off protocol before the transporter arrives at the deliver address, the transporter take any suitable actions (e.g., contact the end user for information on how to best navigate the area around the delivery address) that can reduce the likelihood of delivery delays. However, a single drop-off protocol is not suitable for all types of deliveries to all types of addresses. Embodiments of the invention can advantageously identify an address type associated with a delivery address. By doing so, tailored solutions, based on different address types, can be provided to the transporters to improve the speed and convenience of their item deliveries. Doing so reduces unexpected obstacles for the transporters, and leads to improved HQDR (High-Quality Delivery Rate).

Embodiments can use transporter location data from previous item deliveries to determine an address type associated with a particular delivery address or addresses. For example, the routes that transporters take to transport item to the end users at their delivery addresses provide useful information about the address types associated with the delivery addresses. In some embodiments, transporter location data collected from transporter user devices that can be used to determine address types can include, but is not limited to, GPS latitude data, GPS longitude data, GPS altitude data, GPS accuracy data, accelerometer data, and image data (e.g., pictures of deliveries taken by a transporter user device that may reveal information about the address type associated with a delivery address).

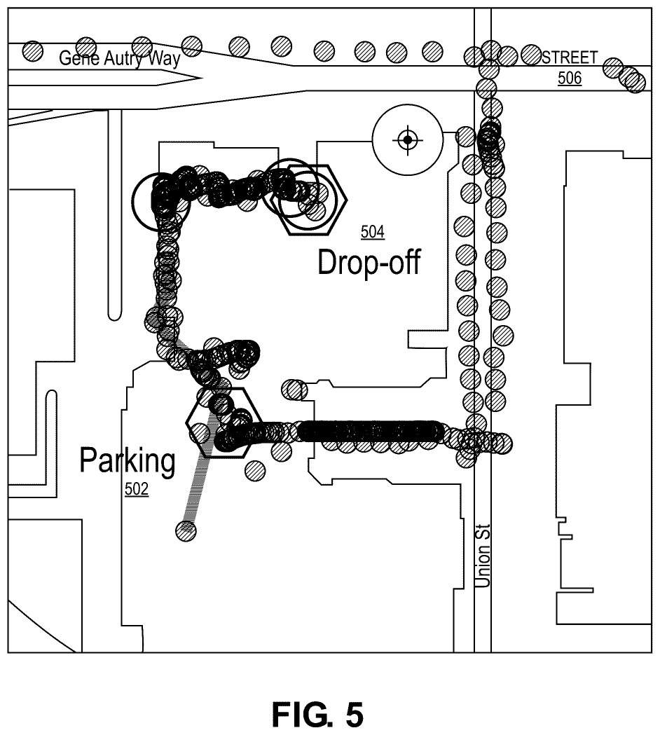

In some embodiments, the transporter user device can transmit to the central server computer the transporter location data associated the transporter's location every five seconds throughout the delivery of an item to a delivery address. As noted above, the transporter location data can reveal information about the address type of the address. For example, in areas where the transporter is moving slowly or not moving at all, a map of the transporter location data (e.g., a dot representing a latitude and longitude of the transporter user device and the transporter) may be clustered. In comparison, in areas where the transporter is driving or walking, the transporter location data may be spread out on a map. Example transporter location data overlaid on a map is shown in FIG. 5.

Generally, it can be expected that the transporter location data associated with delivering an item to a delivery address varies across address types. For example, for a single-family home, the transporter location data may indicate a short path from a parking spot to a drop-off point at a delivery address. For a high-rise apartment building, the transporter location data including GPS latitude, GPS longitude, and GPS altitude data may indicate that the transporter is in an elevator in the high-rise apartment building.

In addition to the transporter location data, satellite imagery and image recognition data may also be used to determine the destination type. In some embodiments, the transporter and/or end user information about delivery addresses may be used to determine the address type. For example, chat dialogues between end users and transporters can reveal the address types associated the delivery addresses of the end users.

Methods according to embodiments can enable a server computer comprising a machine learning model to determine an address type associated with a delivery address. The server computer can receive an incoming fulfillment order comprising the delivery address, items to be delivered to the delivery address, delivery instructions, and a service provider that can provide the items. The server computer can then receive historical transporter location data associated with the delivery address. In some embodiments, the server computer can utilize image recognition of satellite imagery to determine a boundary associated with the address, and filter the transporter location data by the boundary. For example, a boundary of what appears to be an office complex can be identified in satellite imagery using image recognition software, and transporter location data associated with deliveries made to addresses within the boundary can be obtained. The server computer may also utilize a machine learning algorithm to identify clustering of transporter data, which may be referred to as “hotspots.” For example, transporter data with many transporters delivering items to a particular address may show that they are stationary and moving upward just prior to dropping off items to be delivered to that address. The paths of the transporters may cluster during this upward movement and this cluster may be a “hotspot” which may be characterized by an elevator. Based on these and other data, the server computer can determine an address type associated with a delivery address. Once the server computer determines the address type, the server computer can perform further processing to improve the speed and efficiency of a delivery of an item.

In some embodiments, the further processing may comprise transmitting the address type associated with the address to the transporter. By knowing the address type, transporters can plan their route, optimize their time, and reduce the likelihood of delays or errors. Certain address types, such as apartment complexes or gated communities, may have specific entry points or delivery procedures that can be difficult to navigate. By understanding the specific requirements of each address type, transporters can increase the accuracy of their deliveries and avoid unnecessary backtracking or confusion, and can provide for a more personalized and tailored delivery experience. Additionally, knowing the address type can enable transporters to communicate more effectively with end users. For example, if a delivery requires navigating a large office building, the transporter can provide the end user with real-time updates about their progress or any potential delays.

In some embodiments, item fulfillment organizations can use the address type as a classifier to provide tailored solutions. For example, the further processing may comprise tailoring delivery instructions for the transporter. Tailored delivery instructions can help guide the transporter to the drop-off location when they arrive at the delivery address. As a result, transporters may spend less time searching for the drop-off location. Here are some examples of tailored instructions for specific address types:

### 1. Hospitals:

Delivery instructions for hospitals may include specific entrances or loading docks to use, required forms to complete, or instructions for contacting the recipient or a specific department.

### 2. Schools:

Delivery instructions for schools may include directions to the main office or front desk, information about any security procedures, or instructions for accessing a specific classroom or building.

3. Military campuses:

Delivery instructions for military campuses may include information about required identification or documentation, instructions for accessing a specific gate or checkpoint, or directions to a specific building or department.

### 4. Casinos:

Delivery instructions for casinos may include specific entrances to use, instructions for contacting the recipient or a specific department, or information about any security or access procedures.

In some embodiments, the further processing may comprise prompting the end user for specific data related to the address. Embodiments can ask the end user specific questions about the delivery address when the end user submits the fulfillment request, such as: entrance codes, the floor that they are living on, locker availability, and front desk availability. Other examples of tailored questions based on specific address types may include:

### 1. Building Name:

If the delivery is to a large office building or commercial complex, it is possible to ask for the building name or suite number to ensure the delivery is sent to the correct location.

### 2. Apartment Unit:

If the delivery is to an apartment complex, it is possible to ask for the specific building number and apartment unit to ensure that the package is delivered to the correct location.

### 3. Parking Slots:

If the delivery is to an area with limited parking, such as a downtown district or shopping center, it is possible to ask if the end user has reserved parking or any other special instructions for parking.

### 4. Curbside Parking:

If the delivery is to a residential area, it is possible to ask if the end user has any preferences for curbside delivery or if there are any parking restrictions. By asking tailored questions based on the specific address type, it is possible to ensure a smooth and hassle-free delivery experience for the end user.

Embodiments may also be used to determine the address type of the address associated with the service provider location. Once the transporter arrives at the service provider location, they may need to retrieve the order. The pick-up protocol may vary depending on the service provider location. For example, some service provider locations may have a designated area for orders associated with an item fulfilment organization (e.g., pickup counter), while other service provider locations may not. Embodiments can determine the address type of the service provider location and perform further processing to transmit curated pick-up instructions to the transporter.

Some service provider locations may be within a shopping mall, or require the transporter to park the transporter vehicle in a difficult to navigate parking garage. In this case, knowing the address type of the service provider location may be useful for identifying parking protocol. As such, the time transporters spend searching for parking, wait times, as well as the likelihood of a parking ticket, may be reduced as a result.

Being able to classify fulfilment requests by address type can allow item fulfillment organizations to make more accurate predictions.

An item fulfilment organization may wish to perform further processing based on the address type of an address. For example, for a given item fulfilment request, the item fulfilment organization may use algorithms to predict an estimated time of arrival, detect fraud, or determine an estimated cost associated with the request. In each case, the address type of the address associated with the fulfilment request may be a target variable. As such, embodiments can allow for better predictions by various algorithms.

For example, when an item fulfilment organization receives an item fulfilment request (e.g., a food delivery order) from an end user, the item fulfilment organization may transmit an estimated time of arrival to the end user. To ensure end user satisfaction, the order should be received by the end user at or close to the estimated time of arrival. The estimated time of arrival is influenced mainly by the item preparation time and the item delivery time. One variable that can impact the item delivery time is the address type associated with the delivery address. If the address type of the delivery address is in a high-rise building, it may take additional time to take an elevator up multiple floors. In another example, if the address type of the delivery address is a single-family home, the doorstep where the item is to be delivered may be easily accessible and therefore may be associated with a shorter delivery time. Thus, the address type of the delivery address may be considered a target variable or key feature in a machine learning algorithm that predicts an estimated time of arrival.

In another example, the address type can be factored into order subtotal calculations. Knowing the address type of the delivery address and/or the service provider location address, it is possible to determine a distance that the drop-off or pick-up protocol requires the transporter to carry the order, which may impact the cost associated with the fulfilment request. For example, if the transporter is required to carry an order around a complex community or up multiple flights of stairs, the order may be associated with a higher subtotal since it may be a high-effort order.

Many item fulfilment organizations utilize data analysis techniques to enhance the transporter and end user experience. Item fulfilment organizations may wish to reduce the amount of fraud, create targeted advertisements, and conduct surveys. Knowing the address type may be useful for each of these objectives.

Knowing the address type may be useful for fraud detection techniques. By analyzing the address type, it is possible to identify any unusual patterns or anomalies in the delivery addresses. For example, if multiple orders are being placed from the same address type but with different names and payment methods, it could indicate potentially fraudulent activity. It is possible to then investigate further and take appropriate actions to prevent any fraud or misuse of the platform.

It is possible to use address-type information to design and target experiments, advertisements, and surveys. By understanding the address type, it is possible to target advertisements more effectively. For example, if an address is identified as a residential location, companies may want to target their ads towards products or services that are more relevant to individual consumers, such as household items, clothing, or personal care products. On the other hand, if an address is identified as a commercial location, companies may want to target their ads toward business-related products or services. Understanding the different types of addresses can assist in directing surveys to obtain feedback from transporters. By utilizing this information, it is possible to optimize the delivery process, prevent fraudulent activities, and improve the overall delivery experience for end users.

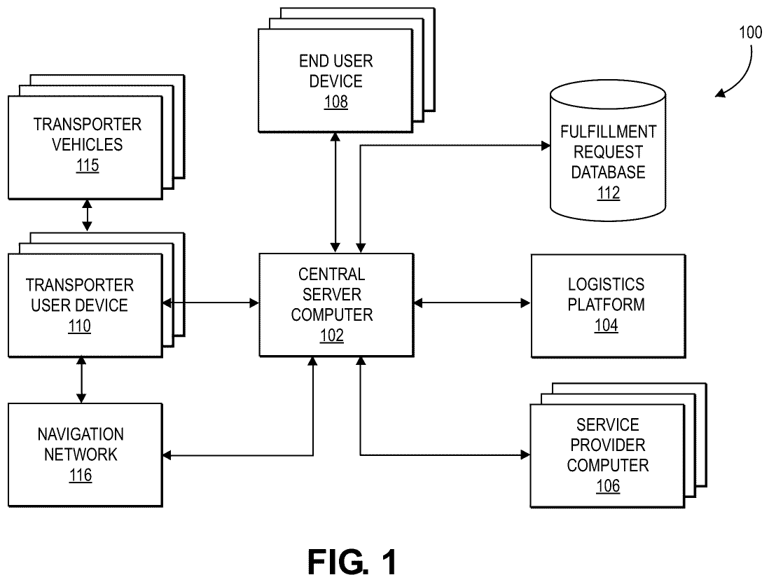

FIG. 1 shows a system 100 according to some embodiments of the present disclosure. The system 100 can comprise one or more end user devices 108, a central server computer 102 (sometimes referred to more generically as a “server computer”), a fulfillment request database 112, a logistics platform 104, one or more transporter user devices 110 (sometimes referred to as “transporter device” or “transporter computers”), and a navigation network 116. FIG. 1 also shows one or more transporter vehicles 115, which may be operated by “transporters”, e.g., users of the transporter user devices 110. As an example, a transporter can be a delivery person, a transporter user device (or transporter computer) 110 can comprise that delivery person's mobile phone, and a transporter vehicle 115 can be a car that is operated by the delivery person.

For simplicity of illustration, a certain number of components are shown in FIG. 1. It should be understood, however, that embodiments of the present disclosure may include more than one of each component. In addition, some systems according to embodiments of the present disclosure may include a lesser number of components or a greater number of components than those shown in FIG. 1.

The central server computer 102 can be in operative communication with the one or more end user devices 108, the fulfillment request database 112, the logistics platform 104, the one or more service provider computers 106, the transporter user device 110, and in some embodiments, the navigation network 116. Further, the one or more transporter user devices 110 can be in operative communication with the navigation network 116. These devices and computers can communicate with one another by sending messages over a communications network (not pictured). Messages between at the devices in system 100 can be transmitted using a secure communications protocol such as, but not limited to, File Transfer Protocol (FTP); HyperText Transfer Protocol (HTTP); Secure Hypertext Transfer Protocol (HTTPS), SSL, ISO (e.g., ISO 8583) and/or the like.

A communications network may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. The communications network can use any suitable communications protocol to generate one or more secure communication channels. A communications channel may, in some instances, comprise a secure communication channel, which may be established in any known manner, such as through the use of mutual authentication and a session key, and establishment of a Secure Socket Layer (SSL) session.

In more detail, the one or more end user devices 108 can include devices operated by end users (sometimes more generically referred to as “users”). The one or more end user devices 108 can generate and provide fulfillment request messages to the central server computer 102. A fulfillment request message can indicate that a request (e.g., a request for a service, or a request for an item, such as a meal to be delivered) can be fulfilled by one or more service providers operating the one or more service provider computers 106.

The central server computer 102 can facilitate the fulfillment of fulfillment requests received from the one or more end user devices 108. For example, the central server computer can identify a transporter, corresponding to a transporter user device 110 that can satisfy the fulfillment request based on any suitable criteria (e.g., transporter location, service provider location, end user destination, end user location, transporter mode of transportation, etc.). The logistics platform 104 may provide real time data regarding locations of the various service providers, transporters, and end users to the central server computer 102.

The fulfillment request database 112 can store data related to previous (e.g., historical) fulfillment requests. For example, after a fulfillment request is fulfilled, the central server computer 102 can store fulfillment request data in the fulfillment request database 112. For example, the central server computer 102 can store any spatial-temporal fulfillment data (e.g., transporter user device locations over time, transporter user device motion data over time, length of time taken to fulfill the fulfillment request, a fulfillment time, a fulfillment location, etc.), fulfillment service data (e.g., fulfilled services, an amount, a service provider computer identifier, an end user device identifier, a transporter user device identifier, etc.), and any other data relating to the fulfillment request and/or the fulfillment of the fulfillment request.

The one or more service provider computers 106 can include computers operated by service providers. For example, a service provider computer can be a food provider computer that is operated by a food provider (e.g., a restaurant, grocery store, convenience store, etc.). Service providers can use the one or more service provider computers 106 to offer to provide services to the end users of the one or more end user devices 108. A service provider computer 106 can receive requests to prepare one or more items for delivery from the central server computer 102. The service provider computer can initialize the preparation of the one or more items so that they can be delivered to an end user of an end user device 108 by a transporter user of a transporter user device 110.

The one or more transporter user devices 110 can be devices (e.g., computers) operated by transporters. As examples, the one or more transporter user devices 110 can be smartphones, wearable devices, personal assistant devices, etc. A transporter can request to fulfill an end user's fulfillment request. For example, the transporter user device 110 can generate and transmit a request to fulfill a particular end user's fulfillment request to the central server computer 102. The central server computer 102 can notify the transporter user device 110 of the fulfillment request. The transporter user device 110 can respond to the central server computer 102 with a request to perform the delivery to the end user as indicated by the fulfillment request.

The navigation network 116 can provide navigational directions to the one or more transporter user devices 110. For example, a transporter user device 110 can obtain a location from the central server computer 102. The location can be a service provider parking location, a service provider location, an end user parking location, an end user location, etc. The navigation network 116 can provide navigational data that can be used to navigate to the location. For example, the navigation network 116 can be a global positioning system that provides location data to the transporter user device 110.

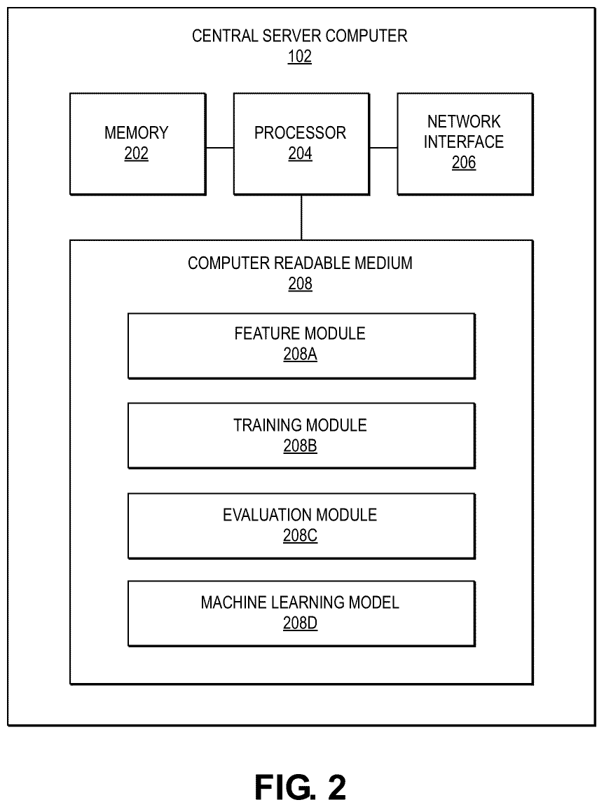

FIG. 2 shows a block diagram of a central server computer 102 according to embodiments. The central server computer 102 may comprise a processor 204. The processor 204 may be coupled to a memory 202, a network interface 206, and a computer readable medium 208. The computer readable medium 208 can comprise a feature module 208A, a training module 208B, an evaluation module 208C, and a machine learning module 208D.

The memory 202 can be used to store data and code. For example, the memory 202 can store input data, features, machine learning models, weights, etc. The memory 202 may be coupled to the processor 204 internally or externally (e.g., cloud based data storage), and may comprise any combination of volatile and/or non-volatile memory, such as RAM, DRAM, ROM, flash, or any other suitable memory device.

The computer readable medium 208 may comprise code, executable by the processor 204, for performing a method comprising: receiving, by a server computer comprising a machine learning model from an end user device operated by an end user, a fulfillment request for an item the fulfillment request comprising an address of the end user, determining, by the server computer comprising the machine learning model, an address type associated with the address of the end user, and performing, by the server computer comprising the machine learning model, further processing based upon the address type associated with the address of the end user.

The feature module 208A may comprise code or software, executable by the processor 204, for determining and/or evaluating features. The feature module 208A, in conjunction with the processor 204, can extract features from a dataset. Feature extraction can start from an initial set of measured data (e.g., data from the dataset). The feature module 208A, in conjunction with the processor 204, can obtain the dataset from a memory or database. The feature module 208A, in conjunction with the processor 204, can build derived values (e.g., features) from the dataset that can be intended to be informative and non-redundant, facilitating the subsequent learning and generalization steps, and in some cases leading to better human interpretations. Feature extraction can be related to dimensionality reduction of the dataset.

When the input data to an algorithm is too large to be processed and it is suspected to be redundant (e.g., the same measurement in both feet and meters, or the repetitiveness of images presented as pixels), then it can be transformed into a reduced set of features (also named a feature vector). Determining a subset of the initial features is called feature selection. The selected features can contain the relevant information from the input data, so that the desired task (e.g., determining predicted values and predicted ranks) can be performed by using this reduced representation instead of the complete initial data.

The feature module 208A, in conjunction with the processor 204, can perform feature extraction/dimensionality reduction techniques including independent component analysis, isomap creation, principle component analysis, latent semantic analysis, partial least squares, multifactor dimensionality reduction, nonlinear dimensionality reduction, embedding, autoencoders, etc.

The training module 208B can include may comprise code or software, executable by the processor 204, for training machine learning model(s). The process of training a machine learning model involves providing a machine learning algorithm with training data to learn from. The training module 208B, in conjunction with the processor 204, can input training data into the machine learning model for training. The training data can include labels that indicate the target attribute of the data.

The training module 208B, in conjunction with the processor 204, can aid the learning algorithm in finding patterns in the training data that map the input data attributes to the target. The training module 208B, in conjunction with the processor 204, can output a trained machine learning model that captures these patterns.

The training module 208B, in conjunction with the processor 204, can further train the trained machine learning model with additional training data that may be obtained after the initial training is complete. The training module 208B, in conjunction with the processor 204, can continuously train the trained machine learning model over time.

The evaluation module 208C can include may comprise code or software, executable by the processor 204, for evaluating data and machine learning model(s). The evaluation module 208C, in conjunction with the processor 204, can utilize the trained machine learning model to obtain predictions on new data for which the target (e.g., the predicted value and the predicted rank) are unknown. The evaluation module 208C, in conjunction with the processor 204, can input historical data into the trained machine learning model for evaluation. The trained machine learning model can output an address type, an estimated time for the transporter to arrive at a service provider, and an estimated parking and pickup time, a total delivery time, etc.

The machine learning module 208D can include any of the above described machine learning models including neural networks, support vector machines, etc.

The network interface 206 may include an interface that can allow the central server computer 102 to communicate with external computers. The network interface 206 may enable the central server computer 102 to communicate data to and from another device (e.g., the logistics platform 104, the one or more service provider computers 106, the end user device 108, the transporter user device 110, etc.). Some examples of the network interface 206 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 206 may include Wi-Fi™. Data transferred via the network interface 206 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 206 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

In some embodiments, the central server computer 102 may be in operative communication with one or more databases. For example, the central server computer 102 can communicate with a dataset database and/or a features database. The databases may be conventional, fault tolerant, relational, scalable, secure databases such as those commercially available from Oracle™ or Sybase™.

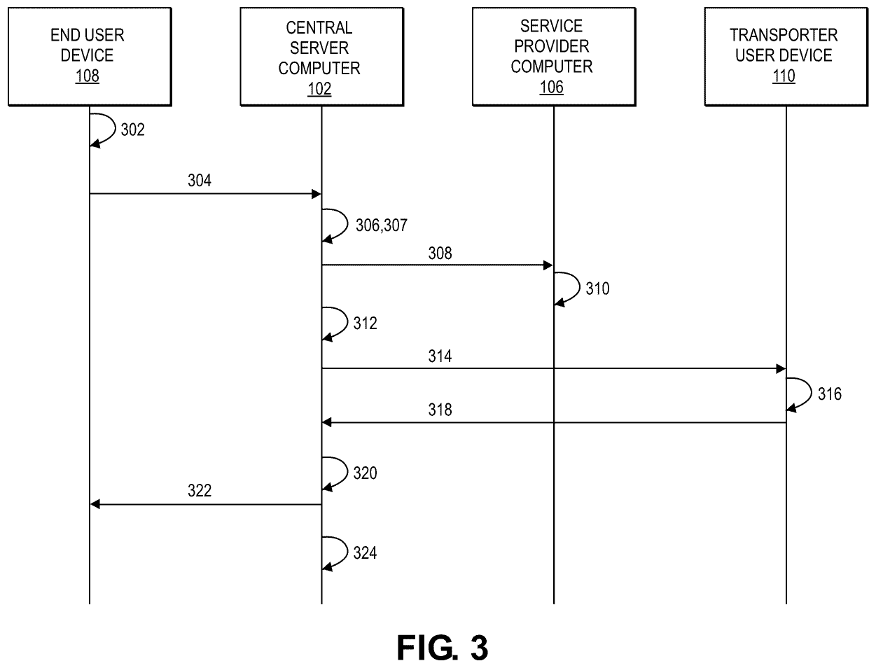

FIG. 3 shows a flow diagram illustrating a preparation and delivery method according to embodiments. The method illustrated in FIG. 3 will be described in the context of the central server computer 102 receiving a fulfillment request message from the end user device 108 to fulfill preparation and delivery of one or more items from a cart to the end user of the end user device 108. The central server computer 102 can communicate with the service provider computer 106 and the transporter user device 110 to fulfill the fulfillment request.

At step 302, the end user device 108 can decide to check out with a cart in a central server computer application installed on the end user device 108. The cart can include one or more items that are provided from a service provider of the service provider computer 106.

At step 304, after checking out with the cart, the end user device 108 can provide a fulfillment request message comprising a delivery address to the central server computer 102. The fulfillment request message can include the one or more items from the cart, and a service provider computer identifier that identifies the service provider computer 106.

At step 306, after receiving the fulfillment request message, the central server computer 102 can perform a transaction process with the end user device 108. For example, the central server computer 102 can communicate with a payment network to process the transaction for the one or more items. The central server computer 102 can receive an indication of whether or not the transaction is authorized. If the transaction is authorized, then the central server computer 102 can proceed with step 308.

At step 307, the central server computer 102 can use a machine learning model to determine an address type associated with the delivery address.

In some embodiments, the central server computer 102 can retrieve transporter location data associated with transporters. For example, the central server computer 102 may retrieve from memory the transporter location data. The transporter location data may comprise historical data associated with the GPS latitude data, GPS longitude data, GPS altitude data, and GPS accuracy data associated with transporters that delivered items to the delivery address or other addresses proximate to the delivery address. As noted above, in some embodiments, a boundary function can be used to determine a set of transporter location data to retrieve and eventually process. This transporter location data can be continually used to train the machine learning model in the central server computer 102.

In some embodiments, the central server computer 102 may utilize other data such as the fulfillment request data input by one or more end users to determine the address type. The fulfilment request data may be related to previous delivery instructions that the one or more end users provided in a fulfillment request (e.g., unit/building information, navigation instructions). For example, for a certain delivery address there may be a plurality of previous delivery instructions from a plurality of end users, each specifying a unit and building. From this data, the central server computer 102 may determine that the address type of the delivery address is a complex community with multiple buildings, each building with multiple units. As another example, the fulfilment request data associated with an address may comprise delivery instructions to leave the order at the front office, which may indicate that the address type is a school. Like the transporter location data, the fulfillment request data can be used as training data to train the machine learning model in the central server computer 102.

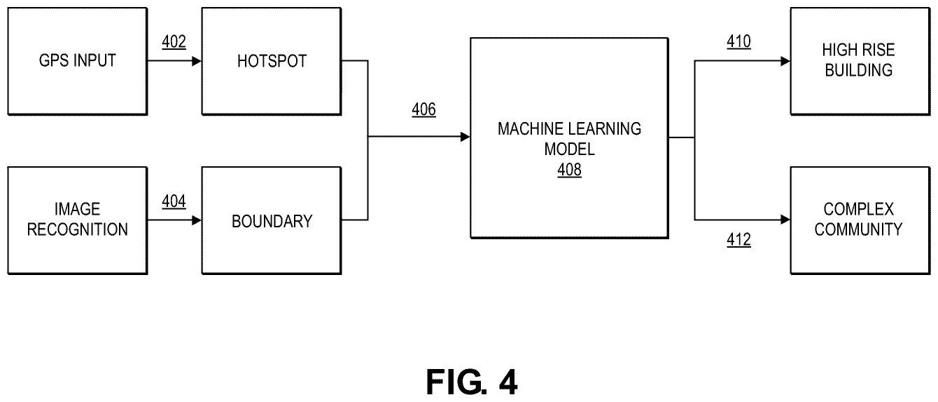

FIG. 4 shows an exemplary flow diagram illustrating a method using a machine learning model to determine address type according to embodiments. The method may be executed by the computer readable medium 208 of central server computer 102, previously described with reference FIG. 2. The machine learning model 408 may be trained using historical transporter location data. Once the machine learning model has been trained, it can be used to make predictions after receiving input data such as a delivery address of an end user. Using GPS input data (e.g., transporter location data) and image recognition data, embodiments can determine if an address is a high rise building or a large complex community.

Example inputs and outputs for a machine learning (ML) model 408 may include the following:

| ML feature | Classification Output |
|---|---|
| GPS Latitude | High Rise Building |
| GPS Longitude | Office Complex |
| GPS Altitude | Single Family Home |
| GPS Accuracy | Apartment Community |
| Boundary Shape | School |
| End user sub-premise information | Hospital |
| Transporter drop off photos | |

At step 402, the central server computer can use transporter location data such as GPS input to identify one or more hotspots. The GPS input data may comprise a plurality of GPS points associated with the same address. GPS input data from a plurality of transporter end user devices can be collected by the server computer, and the data can be clustered to determine hot spots. A hotspot may be an area with a cluster of transporter location data, which can correspond to an elevator, a pick-up spot, a drop-off spot, a parking lot, etc. For example, while a transporter is waiting in a parking lot for order to be ready to be picked up, the GPS data may comprise a plurality of inputs corresponding to the parking lot. This hotspot data can be a further refinement of the transporter location data, and used in the machine learning model to identity address types.

At 404, the central server computer may also use image recognition of satellite imagery to determine a boundary of the address. The boundary may be a geofence around the address. The size of the boundary may be an indicator of address type, as larger boundaries may be associated with address types such as schools and hospitals, whereas smaller boundaries may be associated with single family homes. The boundary data may also be used to filter the GPS input.

At 406, the GPS input data, image recognition data, hot-spot data, and boundary data can continually input to the machine learning model 408 to train it. Together, the boundary and hot-spot data can be used to determine whether the address is associated with a high rise building or complex community. For all of the GPS data inside the boundary, based on 1) elevation changes from the GPS values of a transporter device, and 2) the size of the hotspot, it is possible to predict the type of location that is associated with an address (e.g., a high-rise building or complex community).

To illustrate, the following can be an example of a source of truth. A transporter starts parking around 15:58UTC, and finishes a delivery around 16:07UTC. He got into elevator around 16:00 and his height increased from 40 m˜60 m, which matched to the information that the end user lived on 5th floor. (1921 Union St, Anaheim, CA 92805, USA, Apt/Unit: 5015). But, there are only two GPS records. They show 60 m, it then dropped to 47 m. This means that the attribute of “altitude” can be used in the prediction of the address type for the address (e.g., the address type may be a high-rise apartment building).

The accuracy of the address type predictions made by the machine learning model can be evaluated at a later time, and any weights or parameters in the machine learning model can be adjusted accordingly.

Referring back to FIG. 3, at step 308, the central server computer 102 can provide the fulfillment request message, or a derivation thereof, to the service provider computer 106. The central server computer 102 can determine which service provider computer of a plurality of service provider computers to communicate with based on the service provider indicated in the fulfillment request message. For example, the fulfillment request message can indicate that the one or more items are provided by the service provider of the service provider computer 106. The central server computer 102 can identify the service provider computer 106 using the service provider computer identifier in the fulfillment request message.

At step 310, after receiving the fulfillment request message, the service provider computer 106 can initiate preparation of the one or more items. For example, the service provider computer 106 can alert service providers (e.g., those preparing the items) at the service provider location. The service providers can prepare the one or more items for pick up by a transporter.

At step 312, after determining the address type associated with the delivery address, and after providing the fulfillment request message to the service provider computer 106, the central server computer 102 can determine one or more transporters operating one or more user devices that are capable of fulfilling the fulfillment request message. The central server computer 102 can determine the one or more transporters from the transporter user devices. The central server computer 102 can determine the one or more transporter user devices based on whether or not the transporter user device is online, whether or not the transporter user device is already fulfilling a different fulfillment request message, a location of the transporter user device, etc.

At step 314, after determining the one or more transporter user devices, the central server computer 102 can provide the fulfillment request message, or a derivation thereof, to the one or more transporter user devices including the transporter user device 110. In some embodiments, the fulfillment request message can comprise the address type of the service provider address and/or the delivery address. It may also include additional information about the address type, which can help the transporter delivery the item to the end user.

At step 316, after receiving the fulfillment request message, the transporter of the transporter user device 110 can determine whether or not they want to perform the fulfillment. The transporter can decide that they want to perform the delivery of the one or more items from the service provider location to the end user location. The transporter user device 110 can generate an acceptance message that indicates that the fulfillment request is accepted.

At step 318, after generating the acceptance message, the transporter user device 110 can provide the acceptance message to the central server computer 102.

After providing the acceptance message to the central server computer 102, the transporter user device 110 can communicate with the navigation network 116 and the transporter can proceed to the service provider location to obtain the one or more items. The transporter user device 110 can then receive input from the transporter that indicates that the transporter obtained the one or more items (e.g., the transporter selects that they picked up the items). The transporter user device 110 can then communicate with the navigation network 116 and the transporter can then proceed to the end user location to provide the one or more items to the end user. In some embodiments, the transporter user device 110 can provide update messages to the central server computer 102 that include a transporter user device 110 location and/or event data (e.g., items picked up, items delivered, etc.).

When the transporter moves, the transporter's transporter user device 110 may frequently transmit to the central server computer 102, the GPS latitude data, GPS longitude data, GPS altitude data, and GPS accuracy data of the transporter user device 110. In this way, the central server computer 102 can obtain current transporter location data associated with the delivery address.

In some embodiments, the central server computer 102 may transmit to the transporter user device 110 tailored delivery instructions to the transporter user device 110. The tailored delivery instructions can help guide the transporter to the drop-off location when they arrive at the delivery address.

In some embodiments, after receiving the acceptance message, the central server computer 102 can notify the other transporter user devices that received the fulfillment request message that the fulfillment request is no longer available.

At step 320, at any point after receiving the acceptance message, the central server computer 102 can check the status of the fulfillment request. For example, the central server computer 102 can determine the location of the transporter user device 110 and can determine an estimated amount of time for the transporter user device 110 to arrive at the end user location.

At step 322, the central server computer 102 can provide an update message to the end user device 108 that includes data related to the fulfillment of the fulfillment request message. The data can include an estimated amount of time, the transporter user device location, event data (e.g., items picked up from the service provider), and/or other data related to the fulfillment of the fulfillment request message.

At step 324, the central server computer 102 can store any data received, sent, and/or processed during the fulfillment of the fulfillment request message into a database. For example, the central server computer 102 can store the address type of the delivery address, and the address type of the service provider address as features into a feature database.

FIG. 5 shows an example of transporter location data associated with the same address from one or more transporter user devices. The path of the transporter goes from the street 506 to parking 502, to drop-off 504. The distance between transporter location data points can be an indicator of hot-spots. The clustered areas where the transporter location data points are most dense are labeled as parking 502 and drop-off 504, where the transporter may spend more time. In contrast, the transporter location data points surrounding street 506 are less dense which may indicate that the transporter was traveling at a faster rate and still in their transporter vehicle. The distance between the hotspots can also be an indicator of address type. In the example shown in FIG. 5, the parking 502 and drop-off 504 have a sizeable distance between them, which may rule out the possibility that the address type is a single family home.

Embodiments of the invention have a number of technical advantages. Embodiments of the invention can use a machine learning model to accurately predict a particular address type associated with a delivery address. By doing so, a central server computer can take pre-emptive actions to ensure that any deliveries to that delivery address proceed as efficiently and as quickly as possible. Given that there can be millions of deliveries very month for some delivery organizations, embodiments of the invention can greatly improve processing efficiencies and reduce the need for computational resources associated with longer delivery times.

It should be understood that any of the embodiments of the present invention can be implemented in the form of control logic using hardware (e.g., an application specific integrated circuit or field programmable gate array) and/or using computer software with a generally programmable processor in a modular or integrated manner. As used herein a processor includes a single-core processor, multi-core processor on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer or other suitable display for providing any of the results mentioned herein to a user.

Any of the methods described herein may be totally or partially performed with a computer system including one or more processors, which can be configured to perform the steps. Thus, embodiments can involve computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, and of the steps of any of the methods can be performed with modules, circuits, or other means for performing these steps.

The specific details of particular embodiments may be combined in any suitable manner without departing from the spirit and scope of embodiments of the invention. However, other embodiments of the invention may relate to each individual aspect, or specific combinations of these individual aspects. The above description of exemplary embodiments of the invention has been presented for the purpose of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary. The use of “or” is intended to mean an “inclusive or,” and not an “exclusive or” unless specifically indicated to the contrary.

All patents, patent applications, publications and description mentioned herein are incorporated by reference in their entirety for all purposes. None is admitted to be prior art.

What is claimed is:

1. A method comprising:
receiving, by a server computer comprising a machine learning model from an end user device operated by an end user, a fulfillment request for an item the fulfillment request comprising an address of the end user;
determining, by the server computer comprising the machine learning model, an address type associated with the address of the end user; and
performing, by the server computer comprising the machine learning model, further processing based upon the address type associated with the address of the end user.

2. The method of claim 1, wherein the address type comprises a high rise building, a school, a hospital, or a complex community.

3. The method of claim 1, wherein determining the address type associated with the address comprises:
determining a boundary using image recognition of satellite imagery; and
filtering for transporter location data using the boundary, the transporter location data associated with transporters that made deliveries to addresses within the boundary.

4. The method of claim 3, wherein the machine learning model is trained using at least the transporter location data and the boundary.

5. The method of claim 4, wherein the transporter location data comprises GPS latitude data, GPS longitude data, GPS altitude data, and GPS accuracy data.

6. The method of claim 1, wherein the further processing comprises transmitting, to a transporter user device associated with a transporter that will deliver the item to the end user according to the fulfillment request, a message comprising the address type.

7. The method of claim 1, wherein the further processing comprises transmitting, to the end user device, a request for specific data related to the address.

8. The method of claim 1, wherein the fulfillment request further comprises a delivery instruction.

9. The method of claim 1, wherein the server computer uses data associated with a plurality of past fulfilment requests associated with the address to determine the address type associated with the address.

10. The method of claim 1, further comprising:
determining, by the server computer, one or more transporter user devices;
providing, by the server computer, the fulfillment request to the one or more transporter user devices, wherein one or more transporters associated with the one or more transporter user devices determine whether or not to accept the fulfillment request;
receiving, by the server computer, an acceptance message from a transporter user device of the one or more transporter user devices;
generating, by the server computer, an update message indicating a status of the fulfillment request; and
providing, by the server computer, the update message to the end user device.

11. The method of claim 10, wherein the fulfillment request is associated with a delivery of one or more items to the end user, the one or more items associated with a service provider.

12. The method of claim 11, wherein the address a service provider location.

13. The method of claim 11, wherein the address is associated with a delivery destination.

14. A server computer comprising:
a processor; and
a non-transitory computer readable medium coupled to the processor, the non-transitory computer readable medium coupled to the processor, the non-transitory computer readable medium comprising a machine learning model, and code, executable by the processor for performing a method comprising:
receiving, from an end user device operated by an end user, a fulfillment request for an item the fulfillment request comprising an address of the end user,
determining an address type associated with the address of the end user, and
performing further processing based upon the address type associated with the address of the end user.

15. The server computer of claim 14, wherein the address type comprises a high rise building, a school, a hospital, or a complex community.

16. The server computer of claim 14, wherein determining the address type associated with the address comprises:
determining a boundary using image recognition of satellite imagery; and
filtering for transporter location data using the boundary, the transporter location data associated with transporters that made deliveries to addresses within the boundary.

17. The server computer of claim 14, wherein the further processing comprises transmitting, to a transporter user device associated with a transporter, the address type.

18. The server computer of claim 14, wherein the fulfillment request further comprises a delivery instruction.

19. The server computer of claim 14, wherein, in the method, the server computer uses data associated with a plurality of past fulfilment requests associated with the address to determine the address type associated with the address.

20. The server computer of claim 14, the method further comprises:
determining one or more transporter user devices;
providing the fulfillment request to the one or more transporter user devices, wherein the one or more transporter user devices determine whether or not to request to accept the fulfillment request;
receiving an acceptance message from a transporter user device of the one or more transporter user devices;
generating an update message indicating a status of the fulfillment request; and
providing the update message to the end user device.
